(19) United States
(12) Patent Application Publication
(10) Pub. No.: US 2015/0365553 A1
(43) Pub. Date: Dec. 17, 2015

(54) LENS UNIT, IMAGE READING DEVICE, AND IMAGE FORMING APPARATUS

(71) Applicants: Atsushi SUGAI, Kanagawa (JP); Yoshiaki NAGAO, Kanagawa (JP)

(72) Inventors: Atsushi SUGAI, Kanagawa (JP); Yoshiaki NAGAO, Kanagawa (JP)

(73) Assignee: Ricoh Company, Ltd., Tokyo (JP)

(21) Appl. No.: 14/727,225

(22) Filed: Jun. 1, 2015

(30) Foreign Application Priority Data
Jun. 11, 2014 (JP) 2014-120577

(51) Int. Cl. H04N 1/024; H04N 1/10; G02B 7/02

(52) U.S. Cl. CPC H04N 1/02418; G02B 7/02; H04N 1/1013

(57) ABSTRACT

A lens unit includes a barrel lens; a single lens disposed downstream in a light incidence direction relative to the barrel lens, having a concave lens surface opposite the barrel lens, being an anisotropic lens in a main and sub-scanning directions, having a gradually increasing thickness from a center to lateral ends, and including fixed faces disposed on a side of the concave lens surface at both lateral ends in the longitudinal direction of a non-optical surface thereof; a single lens holder formed of lens holding parts to support the barrel lens, disposed between the barrel lens and the single lens, and including lens holding faces to be fixed to the fixed faces of the single lens; and an image sensor. The lens unit is configured such that reflected light from a document is focused on the image sensor via the barrel lens and the single lens.

### CROSS-REFERENCE TO RELATED APPLICATION

The present application claims priority pursuant to 35 U.S.C. §119(a) from Japanese patent application number 2014-120577, filed on Jun. 11, 2014, the entire disclosure of which is incorporated by reference herein.

### BACKGROUND

1. Technical Field

Exemplary embodiments of the present invention relate to a lens unit, an image reading device, and an image forming apparatus, and more particularly to a lens unit to focus image data of a document onto an image reading system, an image reading device including the lens unit, and an image forming apparatus including the image reading device.

2. Background Art

Among image forming apparatuses such as copiers, printers, facsimile machines, plotters, or multifunction apparatuses including several functions of the above devices, an image forming apparatus including an image reading device employs a lens unit to focus image information of a document onto an image sensor as image reading means.

In order to realize a more compact image reading device, an approach has been made to make a focusing lens more short-coupled, to have a wider image angle, and more compact. Specifically, the focusing lens is divided into two, a barrel lens and a single lens, so that the coupling length is shortened and a smaller size is achieved, while preventing properties of the lens such as aberration and resolution from degrading.

### SUMMARY

In one embodiment of the disclosure, there is provided an optimal lens unit including a barrel lens; a single lens disposed downstream in a light incidence direction relative to the barrel lens, having a concave lens surface opposite the barrel lens, being an anisotropic lens in a main scanning direction and a sub-scanning direction perpendicular to the main scanning direction, having a gradually increasing thickness from a center of the single lens toward both lateral ends in a longitudinal direction of the single lens, and including fixed faces disposed on a side of the concave lens surface at both lateral ends in the longitudinal direction of a non-optical surface of the single lens; a single lens holder formed of lens holding parts to support the barrel lens, disposed between the barrel lens and the single lens, and including lens holding faces to be fixed to the fixed faces of the single lens; and an image sensor. The lens unit is configured such that reflected light from a document is focused on the image sensor via the barrel lens and the single lens.

In the other embodiments of the disclosure, there are provided an optimal image reading device including an optimal lens unit as described above, and an image forming apparatus including an optimal image reading device.

These and other objects, features, and advantages of the present invention will become apparent upon consideration of the following description of the preferred embodiments of the present invention when taken in conjunction with the accompanying drawings.

### BRIEF DESCRIPTION OF THE DRAWINGS

FIG. 1 illustrates a perspective view of an image forming apparatus to which a lens unit and an image reading device according to embodiments of the present invention are adapted;

FIG. 2 illustrates a perspective view of an image reading device to which a lens unit according to embodiments of the present invention is adapted;

FIG. 3 is an exploded perspective view of the image reading device in FIG. 2;

FIG. 4 is a cross-sectional view of an integrated scanning optical unit of FIG. 2;

FIG. 5 illustrates a perspective view of a lens unit according to a first embodiment of the present invention;

FIG. 6A illustrates a plan view of the lens unit of FIG. 5, and FIG. 6B is an enlarged partial view of a circled part A of FIG. 6A;

FIG. 7A illustrates a shape of a single lens included in the lens unit according to the first embodiment of the present invention; FIG. 7B illustrates a shape of a single lens of a lens unit according to a first reference; and FIG. 7C illustrates a shape of a single lens according to a second reference;

FIGS. 8A and 8B are graphs illustrating heat deformation amounts of single lenses in the depth direction thereof when applied heat, in which FIG. 8A shows heat deformation amounts of a first surface of each lens and FIG. 8B shows heat deformation amounts of a second surface of each lens.

FIG. 9 illustrates a perspective view of a lens unit according to a second embodiment of the present invention;

FIG. 10A illustrates a plan view of the lens unit of FIG. 9, and FIG. 10B is an enlarged partial view of a circled part A of FIG. 10A; and

FIG. 11 illustrates a configuration of an image reading device employing a differential mirror, to which the lens unit according to the first and second embodiments of the present invention is adapted.

### DETAILED DESCRIPTION

Hereinafter, preferred embodiments of the present invention will be described in detail referring to accompanying drawings. In each of the embodiments, a part or component having the same function or shape is given the same reference numeral as long as it can be identified, and once explained, redundant description thereof omitted. To simplify drawings and description, even though explicitly illustrated in the figure with a reference numeral, the part or component to which explanation is not particularly required may not be described without any prescribed notice.

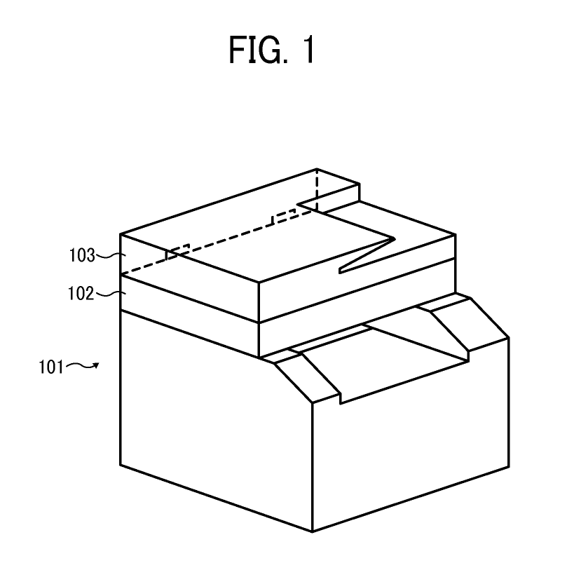

As illustrated in FIG. 1, an image forming apparatus 101 according to embodiments of the present invention includes an image reading device 102, and a document feeder 103 disposed above the image reading device 102. The image forming apparatus 101 includes, for example, a copier, a printer, or a facsimile machine.

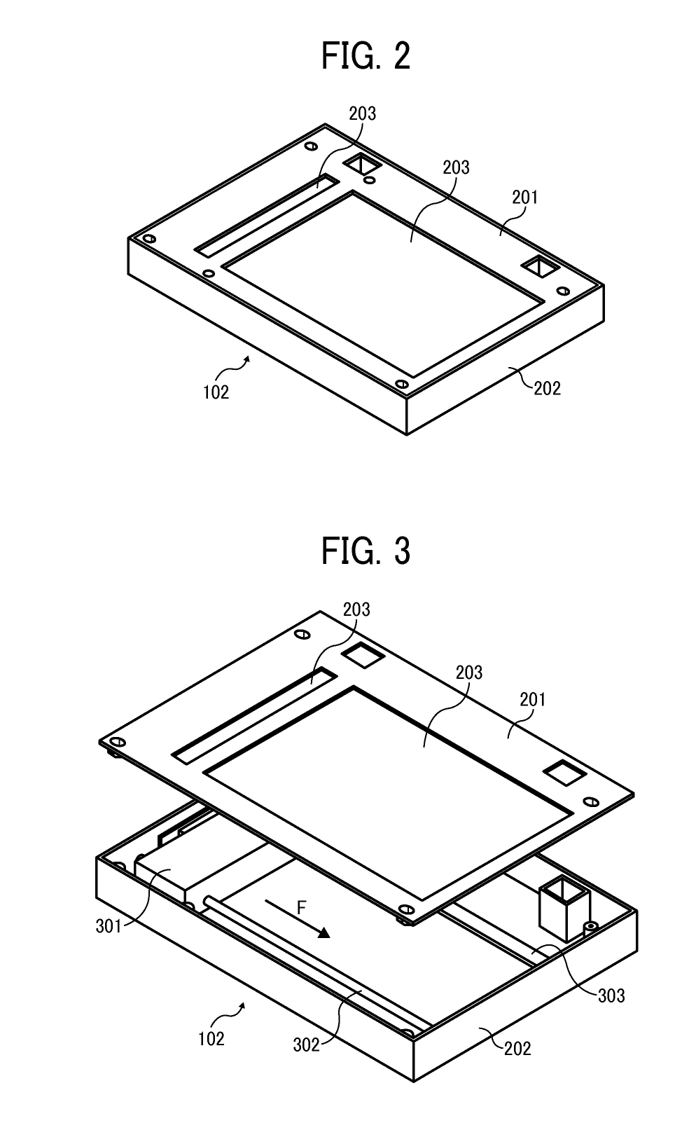

As illustrated in FIGS. 2 and 3, the image reading device 102 includes a scanner cover 201, a scanner frame 202, a contact glass 203, an integrated optical scanning unit 301, a guide rod 302, and a rail 303.

The scanner cover 201 includes a rectangular planar shape and is securely embedded on an upper edge of the scanner frame 202 having a rectangular frame. The scanner cover 201 supports the contact glass 203 on which the document is to be placed.

The integrated optical scanning unit 301 including parts and components, which will be described later, is disposed inside the scanner frame 202. The integrated optical scanning unit 301 is configured to reciprocally move laterally in a sub-scanning direction indicated by an arrow F via a unit moving device, along the guide rod 302 and the rail 303 mounted on the scanner frame 202.

Conventionally, a single lens with a large diameter has been divided into two lenses of different sizes along a main scanning direction and a sub-scanning direction in accordance with a line sensor. From this shape, the single lens is basically formed of resins by molding and fixed at both ends in the longitudinal direction of a non-optical surface thereof, spaced apart from the barrel lens and fixed with an adhesive to edges of the barrel lens. From this structure, heat deformation of the single lens due to the temperature fluctuation adversely affects curvature of the optical surface of the single lens, thereby degrading performance of the lens such as degraded aberration.

Considering the above circumstances, the present invention aims to prevent degradation of the performance of the lens optical surface due to changes of curvature caused by heat deformation of the single lens when temperature fluctuation occurs.

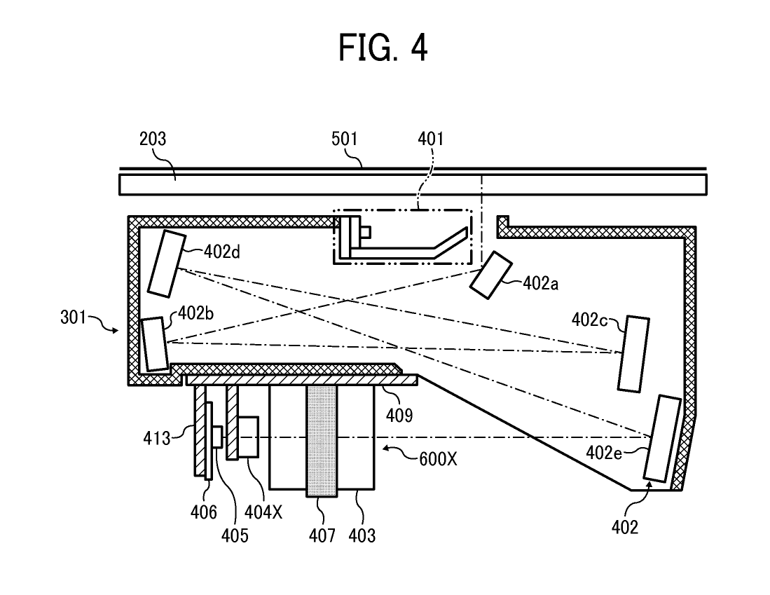

As illustrated in FIG. 4, the integrated optical scanning unit 301 is constructed of a point light source 401, a group of mirrors 402, a barrel lens 403, a single lens 404X, an image sensor 405, and a lens unit mount 409. The barrel lens 403, the single lens 404X, a lens mount 407, and the lens unit mount 409 together form a lens unit 600X.

The point light source 401 is configured to emit light toward the document 501 placed on the contact glass 203 and is formed of LED arrays, and the like. The group of mirrors 402 includes a plurality of reflecting mirrors 402a, 402b, 402c, 402d, and 402e, and directs reflected light beams from the document 501 to the barrel lens 403 and the single lens 404X and introduce them to the image sensor 405.

The barrel lens 403 includes at least one lens and is secured to the lens unit mount 409 with the lens mount 407.

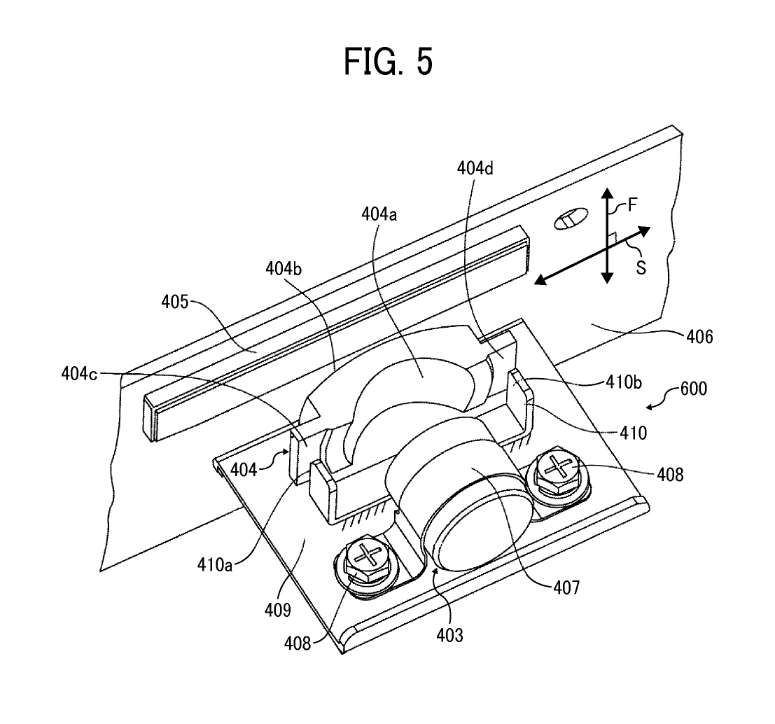

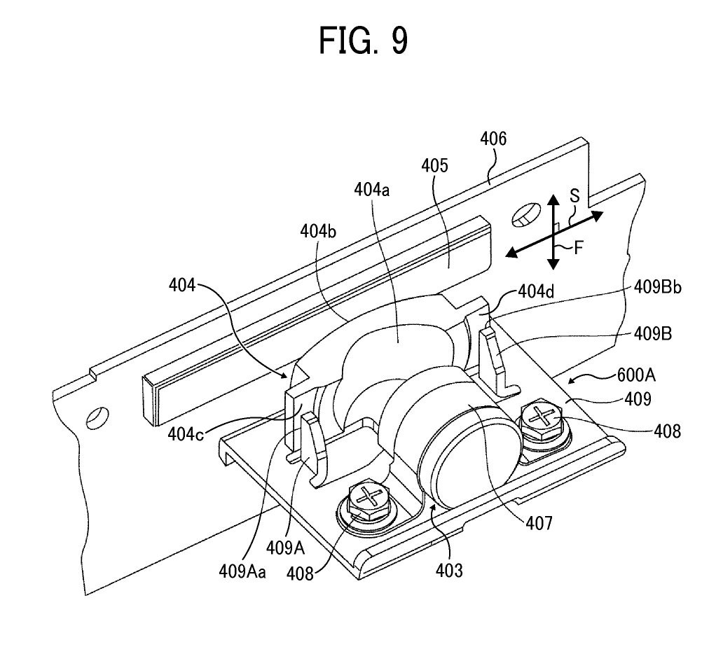

The single lens 404X positions downstream in a light incidence direction relative to the barrel lens 403 and is secured to the lens unit mount 409. The barrel lens 403 and the single lens 404X cause the reflected light bent by the group of mirrors 402 to be focused on the image sensor 405. The single lens 404X has an anisotropic size in a main scanning direction and a sub-scanning direction perpendicular to the main scanning direction sufficient to function as an imaging lens in combination with the barrel lens 403. As a result, similarly to the single lens 404 that forms a lens unit 600 (see FIG. 5) and a lens unit 600A (see FIG. 9), the single lens 404X is formed of resins for the lens from the viewpoint of simpler producing method and lower costs. Preferred resins for the lens include, for example, polymethylmethacrylate (PMMA) resin, and the like.

The image sensor 405 is mounted on a substrate 406, and is secured to the lens unit mount 409 via a bracket 413 disposed to adjust and fix the image sensor 405 thereon. The image sensor 405 serves as an image reading means. The image sensor 405 employs a charge coupled device (CCD) image sensor or a CMOS image sensor.

The lens unit 600X is constructed of the above-described barrel lens 403, the single lens 404X, the lens mount 407, and the lens unit mount 409. The lens unit 600X as well as the other lens units according to first and second embodiments may be adapted not only to the integrated optical scanning unit 301 as illustrated in FIGS. 3 and 4 but to an image reading device employing a differential mirror to be described later.

First Embodiment

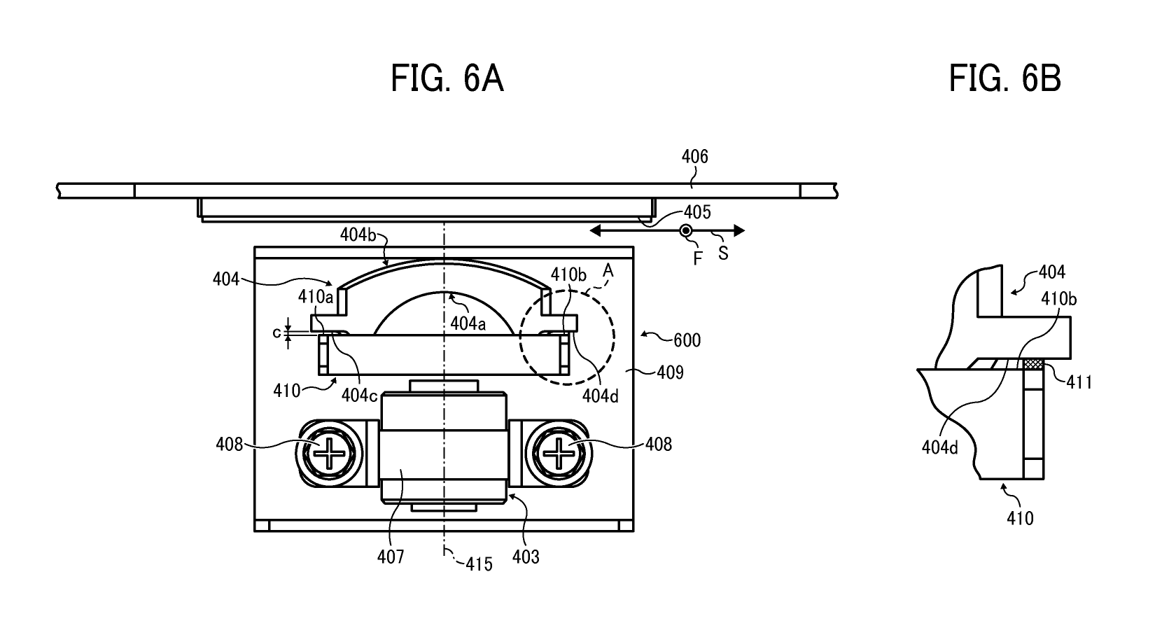

Referring to FIGS. 5 to 8, the lens unit 600 according to a first embodiment of the present invention will be described. FIG. 5 illustrates a perspective view of a lens unit according to the first embodiment of the present invention; FIG. 6A illustrates a plan view of the lens unit of FIG. 5; and FIG. 6B is an enlarged partial view of a circled part A of FIG. 6A.

As illustrated in FIGS. 5 and 6, the lens unit 600 according to the first embodiment employs a single lens 404 instead of the single lens 404X compared to the lens unit 600X of FIG. 4. The lens unit 600 further employs a single lens holder 410. These two points are the main difference from the lens unit 600X. Without the above difference, the first embodiment is similar to what is disclosed by the integrated optical scanning unit 301 of the image reading device 102 as illustrated in FIG. 4. Herein, focusing on the above difference, the lens unit 600 will be described.

As illustrated in FIGS. 5 and 6, the lens unit 600 is constructed of the barrel lens 403, the single lens 404, a lens mount 407, the lens unit mount 409, and the single lens holder 410. The lens unit 600 is configured to focus reflected light from the document on the image sensor 405. FIGS. 5 and 6 are views upside down of FIG. 4.

The barrel lens 403 includes a lens barrel and a plurality of rotationally symmetric lens that is included and held inside the lens barrel. The plurality of rotationally symmetric lens is configured to be rotation-adjustable about an optical axis 415. The barrel lens 403 includes a lens mount 407 extending along a periphery of the barrel lens 403, bolts 408 to fasten both lateral ends of the lens mount 407 to the lens unit mount 409, so that the barrel lens 403 is secured to the lens unit mount 409.

The lens unit mount 409 is formed of a metal or steel plate to position the above components thereon with a certain rigidity. The lens unit mount 409 supports the barrel lens 403 via the lens mount 407, and as will be described, supports and holds the single lens 404 as well.

The single lens 404 positions downstream in a light incidence direction relative to the barrel lens 403, has a concave lens surface, that is, a first face 404a, opposite the barrel lens 403, and has a convex lens surface, that is, a second face 404b at a rear side thereof. The single lens 404 is an anisotropic lens in the main scanning direction S and in the sub-scanning direction F perpendicular to the main scanning direction S. The sub-scanning direction F is a vertical direction in FIG. 5 relative to a sensor side of the image sensor 405. The single lens 404 has a gradually increasing thickness from a center of the lens toward both lateral ends in a longitudinal direction (or in the main scanning direction S) of the lens. Further, the single lens 404 includes fixed faces 404c, 404d disposed on a side of the concave first face 404a at both lateral ends in the main scanning direction S.

That is, each of the fixed faces 404c, 404d of the single lens 404 disposed on the side of the first face 404a is formed on a pair of extended portions extending outward from lateral edges of the optical face of the single lens 404 where the reflected light permeates. Each of the fixed faces 404c, 404d of the single lens 404 is formed outside the optical path of the reflected light. As far as each of the fixed faces 404c, 404d of the single lens 404 is formed outside the optical path of the reflected light where imaging of the single lens is not adversely affected, the shape of the fixed faces 404c, 404d is not limited to the extended structure as described above with illustrated in FIGS. 5 and 6.

The single lens holder 410 is disposed on the lens unit mount 409 between the barrel lens 403 and the single lens 404. To securely hold and position the single lens 404, the single lens holder 410 is formed of a metal plate with a certain rigidity by bending. The single lens holder 410 includes planar lens holding faces 410a, 410b, each of which adheres to each of the fixed faces 404c, 404d with an adhesive 411 after positioning adjustment, described below.

Next, positioning and adjustment method of the lens unit 600 will be described.

First, the lens mount 407 is fitted over the barrel lens 403, and both ends of the lens mount 407 are fastened to the lens unit mount 409 with bolts 408 so that the barrel lens 403 is fixed to the lens unit mount 409. Next, the single lens holder 410 is fixed to the lens unit mount 409 while adjusting the lens holding faces 410a, 410b of the single lens holder 410 within a predetermined range relative to the optical axis 415 of the barrel lens 403. To fix the bottom of the single lens holder 410, an ordinary fastening means, such as a screw, swage, or the adhesive can be employed.

Next, as illustrated in FIG. 6A, the fixed faces 404c, 404d of the single lens 404 are secured to the lens holding faces 410a, 410b of the single lens holder 410 with an adhesive 411. In this case, positions of the fixed faces 404c, 404d of the single lens 404 are so adjusted as to have a gap c between the lens holding faces 410a, 410b and the fixed faces 404c, 404d as illustrated in FIG. 6A relative to the barrel lens 403, while holding the single lens 404 using a positioning jig. The gap c is to provide a coating layer for the adhesive 411, for which preferred materials include, for example, ultraviolet curable resins.

As illustrated in FIG. 6A, when the gap c is provided between the fixed faces 404c, 404d of the single lens 404 and the lens holding faces 410a, 410b and positioning adjustment is performed, the ultraviolet curable resin is coated on the gap c and irradiated with ultraviolet rays. Then, the ultraviolet curable resin is immediately cured, so that the fixed faces 404c, 404d of the single lens 404 are secured to the lens holding faces 410a, 410b of the single lens holder 410. Thus, the single lens 404 is secured to the lens holding faces 410a, 410b of the single lens holder 410 via the fixed faces 404c, 404d alone, and the other parts other than the fixed faces 404c, 404d of the single lens 404 are kept untouched.

After the single lens holder 410 is fixed relative to the barrel lens 403, when the single lens 404 is positioned relative to the barrel lens 403 via the single lens holder 410, a dedicated adjustment device is to be used. In the adjustment device, adjustment is performed checking the lens performance of the barrel lens 403 and the single lens 404 exerted in combination.

Each lens unit according to the first embodiment, a first reference example, or a second reference example was compared by subjecting each single lens to temperature fluctuation under the same conditions except that the shape of the single lens was different. Heat deformation amount of the single lens in the depth direction was obtained.

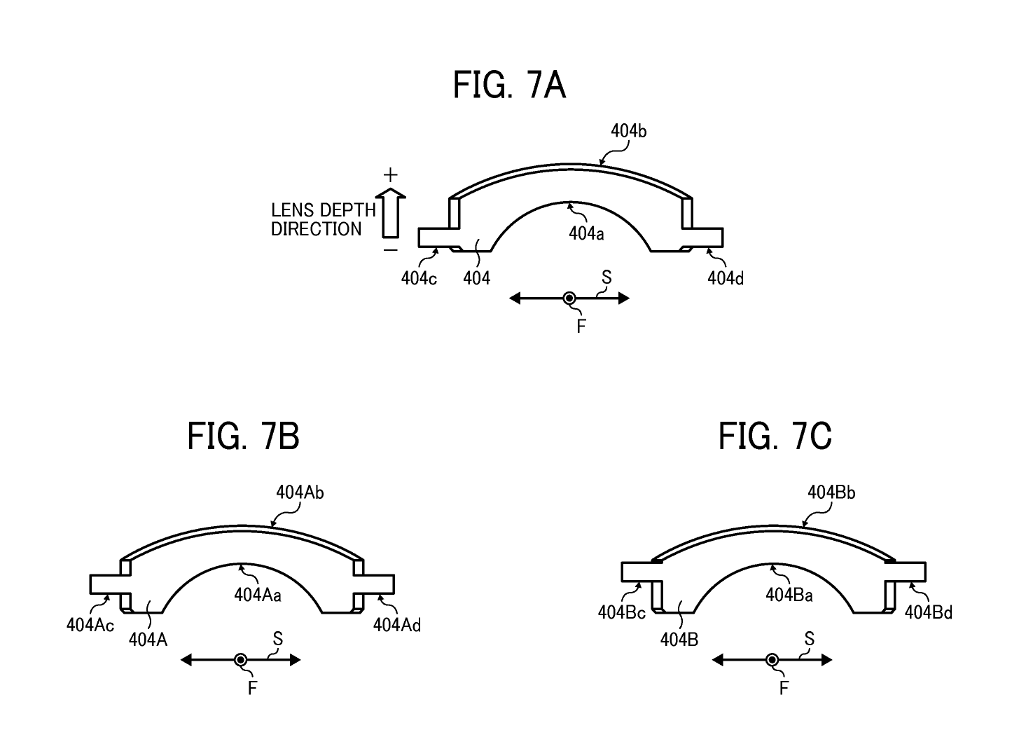

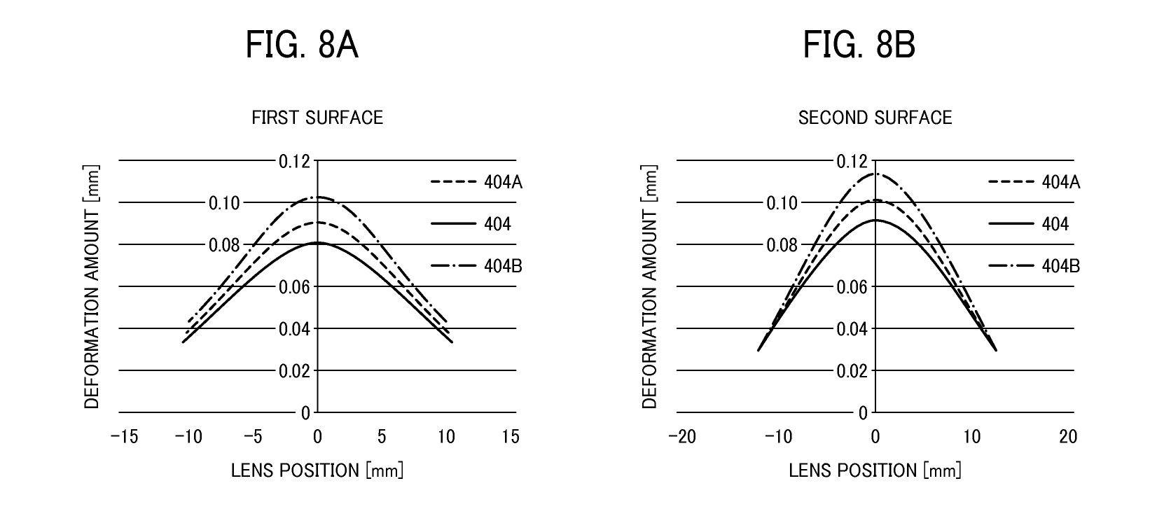

FIG. 7A illustrates the shape of the single lens included in the lens unit according to the first embodiment of the present invention; FIG. 7B illustrates the shape of the single lens of the lens unit according to the first reference example; and FIG. 7C illustrates the shape of the single lens according to the second reference example; FIGS. 8A and 8B are graphs illustrating heat deformation amounts of single lenses in the depth direction thereof when subjected to heat, in which FIG. 8A shows heat deformation amounts of a first surface of each lens and FIG. 8B shows heat deformation amounts of a second surface of each lens.

As illustrated in FIGS. 7A to 7C, all of the single lens 404, the single lens 404A, and the single lens 404B are similarly configured with the same shape of the optical lens surface and the thickness thereof, and similar imaging performance. However, the singles lenses 404, 404A, and 404B are different as to the positions of the fixed parts to be adhered to the single lens holder 410 via the adhesive.

The fixed faces 404c, 404d of the single lens 404 are disposed on a side of the concave first face 404a at both lateral ends in the main scanning direction S. The second face 404b is disposed on a side opposite that of the first face 404a of the single lens 404.

Further, fixed faces 404Ac, 404Ad of the single lens 404A to be secured to the lens holding faces 410a, 410b are formed at both lateral ends in the main scanning direction S of the non-optical portions extending toward the convex second face 404Ab from the concave first face 404Aa. Furthermore, fixed faces 404Bc, 404Bd of the single lens 404B to be secured to the lens holding faces 410a, 410b are formed at both lateral ends in the main scanning direction S of the non-optical portions extending from the convex second face 404Bb.

As to the single lens 404, the single lens 404A, and the single lens 404B, the fixed faces are respectively secured to the lens holding faces 410a, 410b of the single lens holder 410 with the same adhesive, and the fixed parts were subjected to thermal stress varying from 22 degrees C. to 60. As an adhesive, the ultraviolet curable resins were used. The same resinous material for the lens with the same linear expansion coefficient was used for each of the single lens 404, the single lens 404A, and the single lens 404B. As graphs in FIGS. 8A and 8B show, heat deformation amounts of each single lens in the depth direction were obtained for each of the first and second faces and compared. In FIGS. 8A and 8B, a vertical line shows a lens position, in which the lens position that positions on the left from the center of the single lens is represented as “−” (minus); and the lens position that positions on the right from the center of the single lens is represented as “+” (plus). A vertical line shows a heat deformation amount [in mm] in the depth direction of each lens. Following results were obtained from the graphs of FIGS. 8A and 8B. Specifically, it is apparent that the single lens 404 according to the first embodiment of the present invention shows less deformation of the lens in the depth direction thereof concerning the first face 404a and the second face 404b. The single lens 404 includes the fixed faces 404c, 404d disposed at the side of the concave first face 404a more than the other fixed faces. Compared to the single lenses 404A and 404B, the present single lens 404 is configured such that the heat deformation in the fixed portion between the lens holding faces 410a, 410b and each of the fixed faces 404c, 404d is channeled in a normal line direction relative to the lens optical surface. As a result, variation in the curvature radius due to a curved surface of the lens optical surface decreases. Thus, it was determined that the single lens 404 of the lens unit 600 according to the present embodiment is problem-free.

As described above, when temperature fluctuation occurs, the lens unit 600 according to the present embodiment is configured to channel the heat deformation of the single lens 404 between the lens fixed faces in the normal line direction, so that the variation in the curvature due to a curved surface of the lens optical surface can be restricted. Specifically, according to the present embodiment, because the heat deformation of the single lens 404 when temperature fluctuation occurs, resulting in the variations of curvature of the lens optical surface can be reduced, degradation of the lens optical surface can be prevented.

Second Embodiment

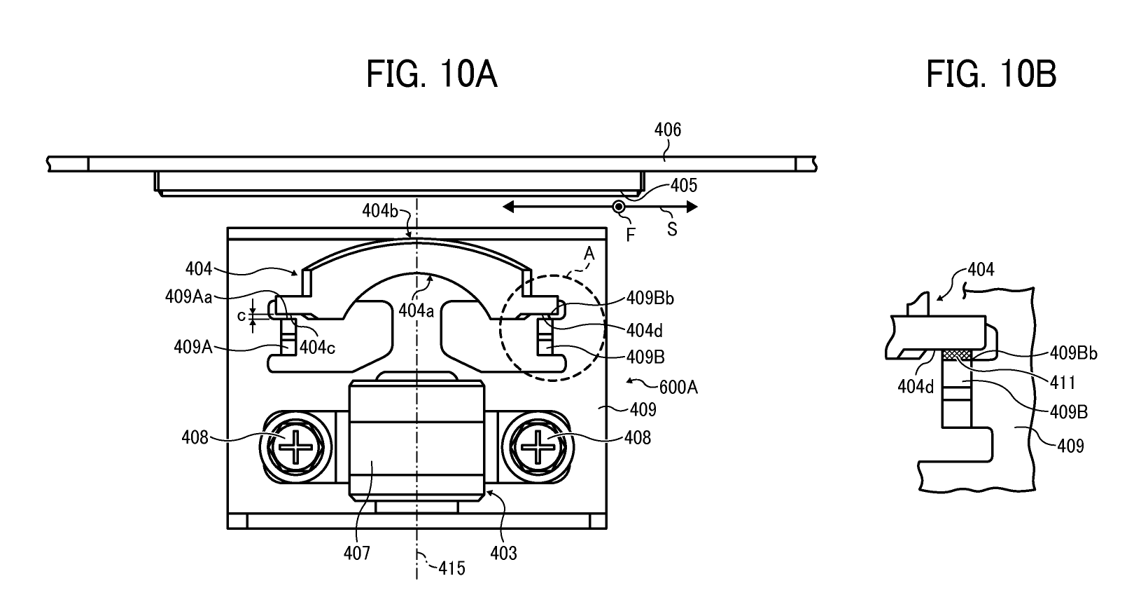

Referring to FIGS. 9 and 10A-10B, the lens unit 600A according to a second embodiment of the present invention will be described.

FIG. 9 illustrates a perspective view of a lens unit according to the second embodiment of the present invention; FIG. 10A illustrates a plan view of the lens unit of FIG. 9; and FIG. 10B is an enlarged partial view of a circled part A of FIG. 10A.

The lens unit 600A according to the second embodiment is different from the lens unit 600 of the first embodiment in that the single lens holder 410 is removed, and instead, lens holding parts 409A, 409B integrally formed with the lens unit mount 409 are employed. Without the above difference, the remaining configuration of the second embodiment is similar to that of the lens unit 600 as illustrated in FIGS. 5 and 6. Hereinafter, focusing on the above difference, the lens unit 600A will be described.

As illustrated in FIGS. 9 and 10A-10B, the lens unit 600A is constructed of the barrel lens 403, the single lens 404, the lens mount 407 and the lens unit mount 409. The lens unit 600A is configured to focus reflected light from the document on the image sensor 405. FIGS. 9 and 10 are views upside down of FIG. 4.

Compared to the lens unit mount 409 as illustrated in FIGS. 5 and 6, the lens unit mount 409 according to the second embodiment includes the right and left lens holding parts 409A, 409B integrally formed by cutting and bending therefrom. Each of the lens holding parts 409A, 409B is disposed on the lens unit mount 409 between the barrel lens 403 and the single lens 404 and has a certain rigidity to exert properties to hold and position the single lens 404 securely. The lens holding parts 409A, 409B include lens holding faces 409Aa, 409Bb, respectively. The lens holding faces 409Aa, 409Bb are disposed opposite and finally adhered to the fixed faces 404c, 404d of the single lens 404, respectively, via the adhesive 411 after the positional adjustment in the similar manner as executed in the first embodiment.

Because the positioning and adjustment of the lens unit 600A is easily understood from the description on the first embodiment, the redundant explanation thereof will be omitted.

As described above, when temperature fluctuation occurs, the lens unit 600A according to the present embodiment is configured to channel the heat deformation of the single lens 404 between the lens fixed faces in the normal line direction, so that the variation in the curvature due to a curved surface of the lens optical surface can be restricted. According to the present embodiment, because the number of components is reduced by one from the first embodiment, so that the second embodiment includes a simpler structure and the degradation of property due to the variation in the curvature of the lens optical surface caused by the thermal contraction of the single lens 404 when a temperature change occurs, can be prevented.

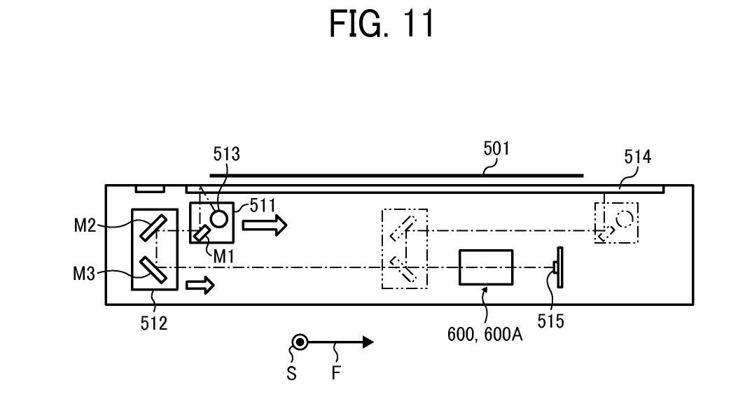

The lens unit 600 or 600A according to the first and second embodiments of the present invention can be adapted not only to the integrated optical scanning unit 301 as illustrated in FIGS. 3 and 4, but to a differential mirror image reading device as illustrated in FIG. 11. FIG. 11 illustrates a configuration of an image reading device employing a differential mirror, to which the lens unit according to the first and second embodiments of the present invention is adapted.

In the differential mirror image reading device, as illustrated in FIG. 11, a first travelling body 511 is moved at a speed double the speed of a second travelling body 512 in the sub-scanning direction F to keep an optical path length or a conjugated length, constant. During the movement, the document 501 placed on a contact glass 514 is exposed by light beams from the light source 513 mounted on the first travelling body 511, reflected light beams from the document 501 are reflected by a plurality of mirrors M1, M2, and M3 of the first and second travelling bodies 511, 512. Then, the reflected light beams from the document 501 pass through the lens unit 600 or 600A serving as an imaging lens, to be introduced to an image sensor 515 formed, for example, of a CCD image sensor, and the like.

Preferred embodiments of the present invention have been described heretofore; however, the present invention is not limited to the described embodiments and various modifications are possible within the scope of claims unless explicitly limited in the description. For example, embodiments may be optionally selected and combined from the first and second embodiments, and other embodiments described herein.

Specifically, for example, the single lens 404 may be formed of glass for the lens, not formed of resins for the lens. This is because, in the future, the cost of the glass-made lens may be reduced due to development of manufacturing technologies of the lens and improvement of materials for the lens even though the single lens is formed with anisotropic sizes in the main and sub-scanning directions, so that the preferred material for the lens may be equally selected from various glasses and resins.

For example, the image forming apparatus to which the present embodiment of the invention may be applied is not limited to the types of the apparatuses as described above, but may be applied to any other types of image forming apparatuses. The present invention may be applied to any image forming apparatuses from copiers, printers, facsimile machines, and further to plotters, and multifunction apparatuses having one or more capabilities of the above devices.

Described effects of the present embodiments are examples of preferred results resulted from the embodiments of the present invention and are not limited to that which is described herein.

Additional modifications and variations of the present invention are possible in light of the above teachings. It is therefore to be understood that, within the scope of the appended claims, the invention may be practiced other than as specifically described herein.

What is claimed is:

1. A lens unit comprising:
a barrel lens;
a single lens disposed downstream in a light incidence direction relative to the barrel lens, having a concave lens surface opposite the barrel lens, being an anisotropic lens in a main scanning direction and a sub-scanning direction perpendicular to the main scanning direction, having a gradually increasing thickness from a center of the single lens toward both lateral ends in a longitudinal direction of the single lens, and including fixed faces disposed on a side of the concave lens surface at both lateral ends in the longitudinal direction of a non-optical surface of the single lens;
a single lens holder formed of lens holding parts to support the barrel lens, disposed between the barrel lens and the single lens, and including lens holding faces to be fixed to the fixed faces of the single lens; and
an image sensor disposed downstream in a light incidence direction relative to the single lens, wherein the lens unit is configured such that reflected light from a document is focused on the image sensor via the barrel lens and the single lens.

2. The lens unit as claimed in claim 1, wherein the single lens holder is positionally adjusted relative to the barrel lens, and
each of the fixed faces of the single lens is secured to the single lens holder with an adhesive.

3. The lens unit as claimed in claim 1, further comprising another single lens holder separate from the single lens holder,
wherein the lens holding parts are formed on the another single lens holder.

4. The lens unit as claimed in claim 1, wherein the single lens is formed of resin.

5. An image reading device comprising the lens unit as claimed in claim 1 to focus image information of the document onto the image sensor.

6. An image forming apparatus comprising the image reading device as claimed in claim 5.
